(19) United States
(12) Patent Application Publication
(10) Pub. No.: US 2003/0168760 A1
(43) Pub. Date: Sep. 11, 2003

(54) Method of making and assembling foam crown molding

(76) Inventor: Salvatore Badalamenti, Shelby Twp, MI (US)

Correspondence Address: BLISS MCGLYNN, P.C., 2075 WEST BIG BEAVER ROAD, SUITE 600, TROY, MI, 48084, US

(21) Appl. No.: 10/385,343

(22) Filed: Mar. 10, 2003

Related U.S. Application Data
(60) Provisional application No. 60/362,789, filed on Mar. 8, 2002.

(51) Int. Cl. B29C 31/00

(52) U.S. Cl. 264/40.1; 156/60; 264/157; 264/132

(57) ABSTRACT

A method of making and assembling foam crown molding includes shaping a volume of foam into at least one strip having a desired shape of crown molding, finishing the at least one strip, and mounting the at least one strip onto at least one partition for decorating the at least one partition.

### CROSS-REFERENCE TO RELATED APPLICATION

This application claims benefit of U.S. Provisional Patent Application 60/362,789 entitled “Method of Making and Assembling Crown Molding” and filed on Mar. 8, 2002.

### BACKGROUND OF THE INVENTION

1. Field of the Invention

The invention relates, generally, to crown molding and, more particularly, to a method of making and assembling crown molding made of foam.

2. Description of the Related Art

Ornamental or decorative moldings are frequently used to improve the appearance of the interior of residential and commercial buildings, in general, and homes and offices, in particular. Crown moldings are common examples of such uses. Crown molding is installed at the juncture of partitions, such as walls and ceilings, within such a building to form a decorative, pleasing finish for the interior of the building.

It was common years ago to have crown moldings created on-site using ornamental plastering techniques. But, because of difficulty in finding and paying for skilled plasterers, most crown moldings are now pre-milled; cut from hard or soft wood, gypsum, marble and other stone, plastics, metal, and acrylic; and installed by a carpenter. Nevertheless, use of these materials has various disadvantages.

In particular, most wood crown molding, for example, is still too expensive for routine use. Also, crown moldings made of wood are combustible. And, wood may warp or split and need refinishing on a regular basis. Plus, the finished appearance of wood is somewhat limited in that multiple color patterns, which realistically simulate desirable stone or marble patterns, are difficult, if not impossible, to attain.

Furthermore and in connection with wood crown molding, when the walls, for instance, within the building are straight, integral crown molding is used. However, in more elaborate building structures, such as those having convex or concave wall surfaces therewithin, or in many older houses within which the surfaces of the walls and ceilings are uneven due to settling of the houses or water damage therewithin, integral crown molding cannot be applied in a single length. Specifically, the minute compression properties of wood preclude installation of straight pieces of wood crown molding in a single length to a concave wall surface, for example. Thus, where a curved wall surface is involved, it is necessary to use crown molding that closely fits the curvature of the wall surface.

In this regard, a conventional method for installing crown molding to a curved wall surface is to assemble multiple short pieces of straight crown molding in end-to-end relation. Since this method leaves multiple angulated joints, to achieve a smoothly curved surface configuration, a filler material is used to float in the joints. The joints are subsequently sanded. Alternatively, a mesh tape is overlaid on the joints, and then foam-coat material is overlaid on the mesh tape. Unfortunately, the mesh tape has a tendency to float within the foam-coat material, and, thus, additional layers of foam-coat material may be necessary to cover the mesh tape. The resultant buildup of foam-coat material may be difficult to smooth out to make the joints unnoticeable. These traditional joint filling-and-floating operations are quite time-consuming and expensive because of the many cuts that are made in the pieces of crown molding to adequately conform them to the curvature of the wall surface. And, considerable manual effort is required to fill, float, and sand the joints.

A problem also occurs during temperature changes. Since wood, plaster, and filler material expand and contract differently in response to temperature and humidity changes, the wood, plaster, and filler material quite readily crack, giving the finished crown molding an undesirable appearance and requiring repair operations.

Another approach for applying crown molding to a curved wall surface is to pre-form the crown molding to the radius of the wall surface. This is a very expensive procedure and not generally satisfactory. In other words, prefabricated curved crown molding, in most cases, does not fit the intended wall surface, and, therefore, expensive adjustments must be made to the crown molding to render it satisfactory.

Moreover, such wood crown molding is exceedingly expensive because it is usually milled from large wood pieces and there is significant waste involved. Since this approach involves cutting curved pieces from straight logs, the grain direction of the logs dictates the length of the pieces supplied. In addition, milling these logs in cross-grain manner causes the grain to rise up and produce a texture impossible to sand out and, thus, showing through the painted surface of the crown molding.

Using materials other than wood to make and assemble crown molding also has its drawbacks. Particularly, some thermoplastics used to form crown moldings are ultraviolet-light sensitive and tend to fade in color while other thermoplastics give off toxic fumes when burned, which could prove to be a health hazard during a building fire. Also, like the finished appearance of wood, that of thermoplastic is somewhat limited in that multiple-color patterns, which realistically simulate desirable stone or marble patterns, are difficult, if not impossible, to attain, whether injection- or extrusion-molding is used as the method of shaping the thermoplastic into a crown molding. Such crown molding is typically attachable to a building by way of spring-biased brackets and cooperative structure on the backside of the crown molding that snaps into the brackets.

Crown moldings made of thin sheet metal, which is typically the case of those made of metal, can dent quite easily, and the dents are relatively difficult to remove. Additionally, a bare- or brushed-metal finish is also not considered very aesthetically pleasing in residences since it has a rather industrial appearance. When metal crown moldings are painted, typically, a scratched or otherwise damaged area of the painted surface shows the substrate having a different color. Metal crown moldings, like wood and thermoplastic crown moldings, are somewhat limited in appearance in that multiple-color patterns, which realistically simulate desirable stone or marble patterns, are difficult, if not impossible, to attain.

Marble, granite, and other stone products are desirable for making crown molding for reasons such as durability and availability of a wide variety of colors and color patterns, which generally never need refinishing. However, such use of natural-stone products is very often cost-prohibitive. Another drawback of stone in making crown molding is that the stone is quite heavy, often requiring a rather substantial and costly support structure for secure installation of the stone.

A further disadvantage of making crown moldings from natural wood and stone is that it is difficult to guarantee coordination of the colors thereof with the colors of the structures to which the crown moldings are assembled and/or surrounding structures, which are made of different materials. It is fairly widely accepted that the best way to color-match two items is to cover both items with the same color. In many situations, the ability to precisely match color is seen to be very important by many interior decorators for aesthetic reasons.

Another problem with using these materials to make crown moldings is that attempting to cut a volume of such a material to a desired shape often results in an imprecise cut. And, since hot glue can melt some of these materials, they must be mounted with aesthetically displeasing nails, screws, clips, or spatial glue, for instance. The resultant rigid mounting does not allow the crown moldings to conform or adjust to uneven wall surfaces.

As can be easily seen, the materials and techniques disclosed to make and assemble crown molding do not result in a lightweight and easy-to-manufacture crown molding that is specifically adapted for decorative interior use. The materials generally used to make and assemble crown molding are not easy to shape and are highly susceptible to chipping, cracking, splintering, splitting, warping, burning, and giving off toxic fumes in a fire. Also, such materials are not adhesively bondable with available glues and color-matched sealants. Crown moldings using such materials are manufactured at a high price as well. In addition, such materials do not very closely simulate marble, granite, and other natural-stone products that have long been used as building materials due to recognition of their durability and beauty. Furthermore, it is significantly less workable to cut such materials.

Accordingly, there is a need for attractive and decorative crown molding that is lightweight and flexible and, upon installation thereof, conforms to uneven surfaces of a wall and/or ceiling and is secure enough to be adequately maintained in place. Further, there is a need for crown molding that is easily manufacturable in large quantities without excessive labor costs and easier, requiring little or no skills, and less costly to install. Moreover, there is a need for crown molding that can be supplied with a pre-finished wood grain, stained or painted, and quickly finished to a smooth exterior surface—which may include sharp corners, a frequently desired shape for crown molding—of any desired shape.

### BRIEF SUMMARY OF THE INVENTION

The invention overcomes the disadvantages in the related art in a method of making and assembling foam crown molding. To make the crown molding, a volume of foam is shaped into at least one strip having a desired shape of crown molding. To assemble the crown molding, the at least one strip is finished and mounted onto a partition or partitions for decorating the partition(s).

An advantage of the method of making and assembling foam crown molding of the invention is that it is creative.

Another advantage of the method of making and assembling foam crown molding of the invention is that the resultant crown molding is professional looking.

Another advantage of the method of making and assembling foam crown molding of the invention is that the crown molding can be prefabricated or custom-made.

Another advantage of the method of making and assembling foam crown molding of the invention is that it permits crown molding to be spray-painted, brush-painted, sponge-painted, stained, or finished with fabric any way to create a desired appearance of the crown molding.

Another advantage of the method of making and assembling foam crown molding of the invention is that the crown molding can be made in contemporary or traditional styles.

Another advantage of the method of making and assembling foam crown molding of the invention is that the crown molding can be made to fit a wide range of various decors.

Another advantage of the method of making and assembling foam crown molding of the invention is that it is designed for the “do it yourself” person.

Another advantage of the method of making and assembling foam crown molding of the invention is that it does not require hiring of a professional painter or installer.

Another advantage of the method of making and assembling foam crown molding of the invention is that the resultant crown molding is fire retardant.

Another advantage of the method of making and assembling foam crown molding of the invention is that it does not require a mold.

Another advantage of the method of making and assembling foam crown molding of the invention is that the resultant crown molding is relatively easier to install.

Another advantage of the method of making and assembling foam crown molding of the invention is that the resultant crown molding is relatively less expensive.

Another advantage of the method of making and assembling foam crown molding of the invention is that the resultant crown molding is relatively lighter.

Another advantage of the method of making and assembling foam crown molding of the invention is that the resultant crown molding is relatively easier to handle.

Another advantage of the method of making and assembling foam crown molding of the invention is that the resultant crown molding takes relatively less time to install.

Another advantage of the method of making and assembling foam crown molding of the invention is that the resultant crown molding costs relatively less to install.

Another advantage of the method of making and assembling foam crown molding of the invention is that the resultant crown molding is relatively more flexible.

Another advantage of the method of making and assembling foam crown molding of the invention is that the resultant crown molding is relatively more fun to install.

Another advantage of the method of making and assembling foam crown molding of the invention is that it does not require any special wood-working skills.

Other objects, features, and advantages of the invention will be readily appreciated as the same becomes better understood while reading the subsequent detailed description of the invention.

### DETAILED DESCRIPTION OF THE INVENTION

The invention overcomes the disadvantages in the related art in a method of making and assembling foam crown molding. The invention will be described in connection with installation of the resultant crown molding on the ceiling and walls of the interior of a bedroom. The interior has at least one “in corner” defined by the intersection of two walls at approximately 90° to each other and at least one “out corner” defined by the intersection of two walls at approximately 270° to each other. Such an “in corner” and “out corner” are standard for the interior of many bedrooms. Also, the ceiling is disposed substantially perpendicularly to the walls. However, those having ordinary skill in the art will appreciate that the crown molding can be installed on any suitable partition or partitions disposed at any suitable relationship to each other. For example, the walls can be disposed less than, equal to, or greater than 90° to each other, and the ceiling can be disposed less than, equal to, or greater than 90° to the walls.

In general, the invention includes shaping a volume of foam into at least one strip having a desired shape of crown molding, finishing the at least one strip, and mounting the at least one strip onto at least one partition for decorating the at least one partition.

In the preferred embodiment of the invention, the method of making the crown molding begins by measuring the angles of the ceilings and walls and easily drawing a profile of a desired shape of the crown molding on an operator screen of a computer by a simplified drawing program. The shapes of the crown molding can be varied and may include left and right “in corner” and “out corner” pieces and “middle” pieces of various sizes. Alternatively, a side view of the desired shape can be drawn on paper, for example, with the dimensions of the desired shape placed on the paper. The drawing can then be transferred to the operator screen. However, those having ordinary skill in the art will appreciate that the desired shape can be expressed in any suitable tangible or intangible medium of expression by any suitable means.

In the preferred embodiment of the invention, the method of making the crown molding continues by cutting a volume of foam into a strip having the profile using a three-axis profile cutter that is controlled by the computer and incorporates a reciprocating blade to reduce dust and provide the widest profile capability. The blade can rotate 360° without reversing rotation, thereby increasing the cutting speed and allowing a greater range of profile to be cut. Alternatively, the volume can be so cut using a hot wire. However, those having ordinary skill in the art will appreciate that the volume can be formed into a strip having the profile using any suitable precision instrument.

In the preferred embodiment of the invention, to assemble the strip of crown molding, first, it must be certain that there is a sufficient amount of strip to complete the area to be molded. By way of example only, to check whether there is such an amount, the strip can be laid on a floor against a wall as a comparison to a corresponding ceiling against a wall. Next, it must be made sure that the proper supplies to complete the assembly are available. The supplies needed include a hot-glue gun or any construction adhesive, a sharp-carving knife, and a ruler. When using some construction adhesives, the strip may need to be held in place. By way of example only, this can be done with large pins about three inches in length or small amounts of glue from a hot-glue gun. Other construction adhesives may need a caulking gun or other similar tool to use the adhesives.

If the strip is to be assembled, or finished, by brush-painting, then latex paint, thinned drywall-joint compound, and primer are also needed. Drywall-joint compound can be thinned with water by adding water to the drywall-joint compound until the resulting mixture has a pancake-batter-like thickness. If the strip is to be finished by spray-painting, then spray paint is all that is also needed. Of course, the color of paint to use is a matter of choice. However, if the strip is to be finished with fabric, then fabric is all that is also needed.

In a preferred embodiment of the invention when the strip is to be spray-painted, the spray-painting must be done in an area that has good air circulation. By way of example only, the strip may be spray-painted on a workbench or floor. All of the strip is spray-painted with as many even coats of spray-paint being applied as is necessary. Once the strip has been completely spray-painted, sufficient time must elapse for the paint to completely dry before installing the strip. Care must be taken not to over-saturate any of the strip with coats of paint. Accordingly, thinner coats are preferred.

In the preferred embodiment of the invention, the strip is then placed against the wall and ceiling to be decorated in the position in which the strip is to be installed. A line—about one inch to three inches long every twelve inches, for example, to indicate depth and projection—can be lightly drawn on the wall and ceiling. A straight line is measured and marked on the top of the back of the strip and carefully cut therealong with the sharp-carving knife to form a notch. The notch represents the top of the strip and is used to prevent installation of the strip upside down. Liquid nails, hot glue, or any other such adhesive are/is applied to the back-upper and back-lower sections of the strip. Then, the strip is mounted, with the lines and notch used as guides.

More specifically, mounting strips into the “in corners” of the room starts at the “in corner” that is farthest away from a door or doors of the room. A left or right “in corner” strip is taken and placed in the position to be installed, making sure that the notch is facing the ceiling and the back of the “in corner” strip is flat against the wall. Then, a line—about one-half inch long every twelve inches, for example—is drawn lightly, but dark enough to be seen, about one-quarter inch outward from the edge of the “in corner” strip. These lines are as guides to help mount the “in corner” strip.

Starting about one-half inch inward from the edge of the “in corner” strip, the adhesive is applied in a substantially straight line across the upper-back and lower-back sections of the “in corner” strip. Some adhesives may not adhere as fast as others. For the adhesives that take a while to adhere, pins—around three inches in length, for instance—may be placed about every twelve inches along the “in corner” strip. Alternatively, amounts of hot glue—each about a dime in size, for instance—may be placed on the top and bottom of the “in corner” strip about every twelve inches.

As soon as the adhesive is applied and the notch is facing the ceiling and the corresponding edge of the “in corner” strip is facing the “in corner,” the “in corner” strip is mounted flatly against the wall. The back and top of the “in corner” strip should be flat against the wall and ceiling, respectively, and all the guides should be covered. At least the corresponding inside edge of the “in corner” strip should be in contact with the adjacent wall. Once the “in corner” strip is in a good position, the length of the strip is pressed against the wall and ceiling to insure a strong bond. And, if the strip is imperfectly cut, it can be pushed and pulled into place. The other “in corner” strip is then mounted in a similar fashion, and the process is continued for all of the “in” corners in the room.

Mounting a strip into an “out corner” of the room begins by making guides and a notch in and applying an adhesive to the back of the “out corner” strip as described above in connection with mounting strips into the “in corners” of the room. As soon as the adhesive is applied and the notch is facing the ceiling and the corresponding edge of the “out corner” strip is facing the “out corner,” the “out corner” strip is mounted flatly against the wall. The back and top of the “out corner” strip should be flat against the wall and ceiling, respectively, and all the guides should be covered. At least the corresponding inside edge of the “out corner” strip should be even with the end of the wall.

Adhesive is then applied to the end of the mounted “out corner” strip adjacent the end of the wall. Next, adhesive is applied to the back of the other “out corner” strip, which is mounted on the wall against the other mounted “out corner” strip. If there is a gap or the “out corner” strips are uneven, the strips can be gently pinched, pushed, and pulled to make them even. The process is continued for all of the “out” corners in the room.

The final step in mounting the strips is mounting the “middle” strips. To do so, the distance of each of the gaps between successive “in corner” and/or “out corner” strips is measured, and the “middle” strips are mounted accordingly.

Upon mounting a strip, a gap may result from the mounted strip to the adjacent wall. In such a case, the gap is measured. Then, a mark is made on the back of another strip of crown molding from an edge thereof for the distance of the gap. More distance may be added such that the length of the other strip is sufficient. Then, a line is drawn with a straight edge, for example, along the back of the other strip. After the line is drawn, it is carved with the sharp-carving knife entirely through the other strip. Now, the other strip fits the gap perfectly and is adhered to the wall.

In another preferred embodiment of the invention, to brush-paint the strips, all of the strips are mounted. Once all the strips have been mounted, sufficient time must elapse for the glue, for example, to completely dry. Then, two coats of the thinned drywall-joint compound are evenly applied to the strips, with each coat drying completely. If necessary, another coat may be applied to the strips. Also, if necessary, after the strips have completely dried, they may be sanded down gently. When the strips have completely dried, one coat of a primer is evenly applied to the strips, which dries completely. When the strips have completely dried, they are finished by evenly brushing any desired color of latex paint, for example, over them.

In another preferred embodiment of the invention, to cover the strips with fabric, the facial width of each of the strips is measured. The fabric is then laid-out on a work area and then cut to twice a measured width. A strip is then ready to be finished. The fabric is laid over the front facial side of the strip evenly, then folded in half, but not creased. An even coat of glue, for example, is sprayed along the front facial side to cover it while it is made sure that the glue covers any grooves in the front facial side. Also, an even coat of glue is sprayed over the fabric. The fabric is rolled over the front facial side from one end to the other end thereof about one-half inch at a time and directly deeply into the grooves in the front facial side. The front facial side is completely finished.

The finished front facial side is turned downward. The fabric is trimmed such that about one-half inch thereof remains for at least partially covering the back facial side of the strip. An even coat of glue is sprayed onto the back facial side and fabric. Then, the fabric is rolled onto the back facial side to at least partially cover the back facial side. The excess fabric is cut evenly with the edges of the strip while it is made sure that the edges of the strip are not cut. The other strips are finished with the fabric in the same way. Two strips are then joined together with an even coat of spray adhesive.

The resultant crown molding of the preferred embodiment of the invention is made of open-cell urethane-ether foam (foam-cushioning polyurethane). However, those having ordinary skill in the art will appreciate that the resultant crown molding can be made of any suitable foam. The resultant crown molding of the invention can also be brush-painted, sponge-painted, stained, wood finished, or finished with fabric anyway to create the look desired.

The resultant foam crown molding of the invention is fire retardant and easier to handle, lighter, more flexible and fun to work with, and less expensive than the crown moldings made of wood, gypsum, marble and other stone, plastic (such as polystyrene), metal, and acrylic, for example. Also, the method of making and assembling crown molding of the invention is designed for a “do it yourself” person, eliminates the need to hire an installer and a painter to install and paint the crown molding, and does not require a mold. And, the resultant crown molding of the invention can be pre-fabricated or custom-made at a shop of a manufacturer for easy installation and a professional look of the crown molding. Furthermore, the resultant crown molding of the invention is just spray-painted, brush-painted, sponge-painted, stained, wood finished, or finished with fabric to the look desired and installed more cost effectively than the crown moldings made by the other methods of making and assembling crown molding. Moreover, the resultant crown molding of the invention can come in many styles to match practically any decor.

The flexibility of the foam crown molding allows it to be installed into corners and curved walls and ceilings, such as in older homes where walls and ceilings have shifted out of position. The flexibility of the foam crown molding allows it also to be cut imperfectly since it can be pushed and pulled into place.

The invention has been described in an illustrative manner. It is to be understood that the terminology that has been used is intended to be in the nature of words of description rather than of limitation.

Many modifications and variations of the invention are possible in light of the above teachings. Therefore, within the scope of the appended claims, the invention may be practiced other than as specifically described.

What is claimed is:

1. A method of making and assembling foam crown molding comprising the steps of:
shaping a volume of foam into at least one strip having a desired shape of crown molding;
finishing said at least one strip; and
mounting said at least one strip onto at least one partition for decorating the at least one partition.

2. A method of making and assembling foam crown molding as recited in claim 1, wherein the desired shape of said crown molding is drawn on the monitor screen of a computer.

3. A method of making and assembling foam crown molding as recited in claim 2, wherein said volume of foam is shaped into said at least one strip by cutting said volume of foam using a cutter that is controlled by said computer.

4. A method of making and assembling foam crown molding as recited in claim 1, wherein said volume of foam is shaped into said at least one strip by cutting said volume of foam using a hot wire.

5. A method of making and assembling foam crown molding as recited in claim 1, wherein said at least one strip is mounted against the at least one partition by placing said at least one strip in the position in which said at least one strip is to be mounted against the at least one partition, indicating depth and projection of the positioned said at least one strip relative to the at least one partition, forming a notch in said at least one strip, applying an adhesive to said at least one strip, and adhesively mounting said a least one strip against the at least one partition with said indicators used as guides and such that said notch is disposed against the at least one partition.

6. A method of making and assembling foam crown molding as recited in claim 5, wherein said adhesive includes any of the adhesives consisting of liquid nails and hot glue.

7. A method of making and assembling foam crown molding as recited in claim 5, wherein the at least one partition includes a ceiling and said method further includes disposing said notch against the ceiling.

8. A method of making and assembling foam crown molding as recited in claim 5, wherein said method further includes placing pins along said at least one strip for further adhering said at least one strip to the at least one partition.

9. A method of making and assembling foam crown molding as recited in claim 5, wherein said method further includes pressing said at least one strip against the at least one partition to insure a substantially strong bond thereto upon mounting said a least one strip against the at least one partition.

10. A method of making and assembling foam crown molding as recited in claim 5, wherein said method further includes pushing and pulling said at least one strip into proper position upon mounting said a least one strip against the at least one partition.

11. A method of making and assembling foam crown molding as recited in claim 1, wherein said at least one strip is finished by brush-painting said at least one strip.

12. A method of making and assembling foam crown molding as recited in claim 11, wherein said at least one strip is finished by mounting said at least one strip onto the at least one partition, applying at least two coats of thinned drywall-joint compound to said at least one strip, allowing the at least two coats of said compound to dry, applying one coat of a primer to said at least one strip, allowing the one coat of said primer to dry, and brushing any desired color of paint over said at least one strip.

13. A method of making and assembling foam crown molding as recited in claim 12, wherein said method further includes sanding down said at least one strip after the at least two coats of said compound are dry.

14. A method of making and assembling foam crown molding as recited in claim 1, wherein said at least one strip is finished with fabric.

15. A method of making and assembling foam crown molding as recited in claim 14, wherein said at least one strip is finished by laying a sheet of said fabric over one facial side of said at least one strip, folding said fabric such that a portion of the one facial side is exposed, applying adhesive to the one facial side and said sheet, rolling said sheet over the one facial side from one end to the other end thereof to finish the one facial side, turning the finished one facial side downward, trimming said sheet such that a portion thereof remains for finishing at least a portion of the other facial side of said at least one strip, applying adhesive along the other facial side and said sheet, rolling said sheet over the other facial side to at least partially finish the other facial side, and cutting any excess of said sheet.

16. A method of making and assembling foam crown molding as recited in claim 1, wherein said at least one strip is finished by spray-painting said at least one strip.

17. A method of making and assembling foam crown molding as recited in claim 1, wherein said at least one strip is finished by installing said at least one strip, spray-painting said at least one strip with at least one coat of spray-paint, and allowing the at least one coat of said spray-paint to dry.

18. A method of making and assembling foam crown molding as recited in claim 1, wherein said at least one strip is finished by any of the methods of covering consisting of sponge-painting, staining, and wood finishing.

19. A method of making and assembling foam crown molding as recited in claim 1, wherein said at least one strip includes a plurality of strips and said plurality of strips are joined together with adhesive.

20. A method of making and assembling foam crown molding as recited in claim 1, wherein said foam is open-cell urethane-ether foam.
